(19) United States
(12) Patent Application Publication
(10) Pub. No.: US 2020/0230800 A1
(43) Pub. Date: Jul. 23, 2020

(54) TRESTLES

(71) Applicant: HARD CORNER, Chassieu (FR)

(72) Inventors: Benoît Dargaud, Saint-Priest (FR); Sylvain Deschanels, Estrablin (FR)

(21) Appl. No.: 16/634,990

(22) PCT Filed: Aug. 2, 2018
(86) PCT No.: PCT/FR2018/051992

§ 371 Date: Jan. 29, 2020

(30) Foreign Application Priority Data
Aug. 3, 2017 (FR) 1757476

(51) Int. Cl. B25H 1/06

(52) U.S. Cl. CPC B25H 1/06

(57) ABSTRACT

A trestle including:
a base intended to rest on the ground, formed of two pairs of posts parallel to each other, the two posts of each of the pairs being secured together at least by an upper crossbar, said pairs being secured together at the level of at least one upper joint, and
a support surface arranged above the base and secured to said base, and extending perpendicularly to a vertical direction when the trestle is in working position.

The upper crossbars extend between the two posts parallel to each other of each of the two pairs and are secured thereto by gluing.

Lateral assembly panels or corner pieces are fastened at least at the level of the upper angles defined by the posts and the associated upper crossbar of each of the two pairs of posts, and on either side of said upper angles.

The upper end of each of the posts is tapered, so that, in working position, the support surface rests on the entire upper section of said posts.

The support surface is only secured to one of the two pairs of lateral posts.

### TECHNICAL DOMAIN

The invention relates to portable support devices, and more particularly trestles.

Such trestles are, in known fashion, capable of being folded, to allow their putting away and storage, and unfolded, and thus in working position, intended to allow their use.

### BACKGROUND

Trestles have already been known for a long time and widely used. They are conventionally formed of a base, intended to rest on the ground, and formed of two pairs of parallel posts, said pairs being secured together at their upper end, where they are hinged, and of a support surface arranged above the base and extending perpendicularly to a vertical direction when the trestle is in working position.

Despite such a widespread use, one of the main difficulties against which users come across is the stability of the trestles and their ability to support relatively significant loads.

Another difficulty also lies in the user-friendliness of the trestles, and particularly in their handling. The user of a trestle indeed frequently has his/her arms burdened with tools or others and at the same time has to displace the trestle on site and to assemble it in working position, which requires laying down the tools that he/he carries to be able to unfold the trestle with both hands to make it operational.

Further, another difficulty associated with the use of such trestles concerns the stability of the elements having to be submitted to operations (cutting, sawing, coating with paint or varnish, etc.) or transformations when they are laid on the upper support surface, said elements being likely to slide or not to be held on said threshold otherwise than by the user's hand, which thus risks affecting, on the one hand the latter's working capacity and, on the other hand, generating alterations of said element to be transformed or to be treated.

Document 2005/224291 describes a trestle of the type in question, where the bases are formed of two pairs of parallel posts connected together by a crossbar, the two pairs being associated with each other by means of two flexible straps. Although the latter effectively enable to fold and unfold the trestles, however, the stability provided to the trestles remains uncertain and by all means insufficient for a large number of applications. Further, such trestles cannot receive too significant loads.

Finally, although such portable support devices are extremely easy to use and widespread, experience however proves that their use raises an issue for a number of operations. Indeed, the upper crossbar(s), or even the support shelf associated with the crossbar(s), are intended to receive, in particular, a board, a pipe, and generally any element intended to be submitted to an operation or a treatment (gluing, cutting, sawing, coating with varnish or paint, etc.). Said element meant to be submitted to any type of operation or treatment are thus likely to slide or not to be held on said trestles otherwise than by the user's hand, thus affecting, on the one hand, the user's working capacity, and risking on the other hand generating alterations of said element to be transformed.

### SUMMARY OF THE DISCLOSURE

The invention aims at overcoming all the above-discussed technical problems by providing a folding trestle essentially made of wood, having a folded position and an unfolded working position.

The trestle comprises:
a base intended to rest on the ground, formed of two pairs of posts parallel to each other, the two posts of each of the pairs being secured together at least by an upper crossbar, said pairs being secured together at the level of at least one upper joint, and
a support surface arranged above the base and secured to said base, and extending perpendicularly to a vertical direction when the trestle is in working position.

According to the application:
the upper crossbars extend between the two posts parallel to each other of each of the two pairs and are secured thereto by gluing;
lateral assembly panels or corner pieces are fastened at least at the level of the upper angles defined by the posts and the associated crossbar of each of the two pairs of posts, and on either side of said upper angles;
the upper end of each of the posts is tapered, so that, in working position, the support surface rests on the entire upper cross-section of said posts; and
the support surface is only secured to one of the two pairs of posts.

In other words, the invention comprises forming a trestle essentially made of wood, having a stability optimized by the mode of assembly of the elements forming the base, mainly due to the presence of corner pieces or lateral assembly panels and, further, to the specific tapered profile of the posts forming said base, and further having its user-friendliness also favored, on the one hand, by the securing of the shelf or upper support surface to a single one of the two pairs of posts.

Advantageously, the two posts forming each of the two pairs of the base are also secured together by means of a lower crossbar, here again extending between the posts and glued to said posts; further, lateral assembly panels or corner pieces are also secured on either side of the lower angles defined by the posts and the lower crossbar.

According to another advantageous feature of the invention, the lateral assembly panels or corner pieces are glued, on the one hand, and further nailed or screwed on the other hand, on the one hand on the respective lateral posts and on the other hand on the respectively upper and lower crossbars, this, to optimize the fastening of the lateral assembly panels or corner pieces, and accordingly to increase the stability of the trestle, particularly when the latter is in unfolded working position.

To further increase the stability of the trestle according to the invention when it is in unfolded position, ballasts are removably fastened in each of the pairs of posts, said ballasts being received on the lower crossbar and inserted between the lateral assembly panels or corner pieces fastened on either side of the above-mentioned lower angle. The ballasts are hollow and for example made of plastic material, and are capable of being filled with water or sand.

Advantageously, the support surface is provided on its upper surface with housings capable of receiving centering and locking means associated with a planar element, intended to be positioned on said support surface, said planar element forming part of a removable accessory.

In other words, it is aimed at removably placing on a trestle and more particularly on a shelf, at the level of which the trestle base is hinged, a planar element such as a secondary shelf, provided with means capable of avoiding its untimely displacement once positioned on said trestle shelf. Thereby, by associating with this accessory either a specific lining, or secondary accessories, the use of such trestles is simplified and optimized.

The planar element may particularly be provided, on its lower surface, with at least one centering and fastening pin, capable of being received in an adapted housing provided for this purpose, formed at the level of the upper support surface of the trestle.

Such a removable accessory, thus typically formed of a shelf, may receive different linings on its upper surface, and for example:
a soft lining, of felt type, more particularly intended for the handling of finished works,
a soft non-skid lining of rubber type, particularly for the handling of mirrors, of glazing panels, or even the assembly of aluminum frames.

According to an embodiment, the planar element is capable of receiving on its upper surface means capable of increasing the load bearing capacity of the trestle with which it is associated, such means being formed of beams sliding in housings defined by an H-shaped structure placed on the upper surface of said planar element. The sliding beams advantageously have a dovetail-shaped cross-section and are received in a housing of complementary shape defined by the H-shaped structure.

The concerned accessory may also be formed of a structure for receiving pipes and tubes, particularly metallic. It is then formed of a planar element provided with areas for receiving tubes or pipes defined by a dihedron and having its lower surface comprising a locating pin, said accessory then being orientable according to any direction of the horizontal plane containing said planar element. Advantageously, the accessory of the invention in this embodiment is formed of two reception structures.

The concerned accessory may also be made of a bench module associated with an elevated work support, enabling to favor the user's working conditions. More particularly, the module is formed of a planar element capable of being positioned on the upper support surface of the trestle, said planar element being topped with an unfolding and folding hinged member having an upper shelf or bench, also planar, extending substantially parallel to the planar element in working position, positioned at its upper end. Advantageously, the planar element is provided with vertical lateral walls capable of positioning at the periphery of the upper support surface, and provided with clamping and holding means, acting in cooperation with said periphery of the upper support surface of the trestle. Further, and according to another advantageous feature, the upper surface of the shelf or upper bench receives a plurality of microbeads, if need be retractable within the thickness of said upper shelf or bench, intended to favor the displacement of the object to be treated.

The concerned accessory may also be formed of a planar surface of relatively large dimension capable of resting on two trestles erected parallel to each other, said planar surface receiving two parallel rows of locating pins.

The concerned accessory may also be made of a fireproof shelf. The shelf, received as in the previous embodiments on the upper support shelf of the trestle, is provided with a peripheral skirt made of a fireproof fabric, placed on the lower surface of said planar element and all along the periphery thereof.

The concerned accessory may further be formed of a shelf coated on its upper surface with a ferromagnetic material intended to receive one or a plurality of blocks provided at their base with a permanent magnet, intended to allow their positioning and fastening in a location selected by the operator on said shelf, said blocks being themselves provided with an opening for receiving a piece or an object, for example, for its painting or its coating with varnish.

### BRIEF DESCRIPTION OF THE DRAWINGS

The foregoing features and advantages of the present invention will now be discussed in the following non-limiting description of a specific embodiment, in relation with the accompanying drawings.

FIG. 1 is a simplified perspective view of a first embodiment of the trestle in unfolded position, and thus in working position.

FIG. 2 is a simplified perspective view of the trestle of FIG. 1 in folded position.

FIG. 3 is a simplified lateral view of the trestle of the previous drawings.

FIG. 4 is a simplified front view of the trestle in unfolded position, and thus in working position, of FIG. 1.

FIG. 5 is a simplified perspective view of the trestle of FIG. 1 in working position, and provided with ballasts to enhance its stability.

FIG. 6 is a simplified perspective view of the trestle according to a second embodiment of the invention.

FIG. 7 illustrates a first accessory of the trestle of the invention, implementing a soft or anti-skid lining, of felt or rubber type.

FIG. 8 is a simplified view of a second accessory of the trestle of the invention illustrating the implementation of modules for receiving pipes or tubes.

FIG. 9 is a simplified perspective view illustrating the implementation of another accessory of the trestle of the invention, relative to a module enabling to increase the load bearing capacity of the trestle, respectively in folded position and in unfolded position.

FIG. 10 is a simplified perspective view illustrating another accessory of the trestle of the invention of workbench type, implemented two trestles erected parallel to each other.

FIG. 11 is a simplified perspective view illustrating another accessory of the trestle of the invention, implementing magnetic blocks capable of being positioned and fastened on a shelf.

FIGS. 12A and 12B are simplified respective perspective and cross-section views of another accessory of the trestle of the invention, formed of a fireproof shelf.

FIGS. 13A and 13B schematically illustrate another accessory of the trestle of the invention, formed of a bench module associated with an elevated work support, respectively in perspective and in partial cross-section view.

### DETAILED DESCRIPTION

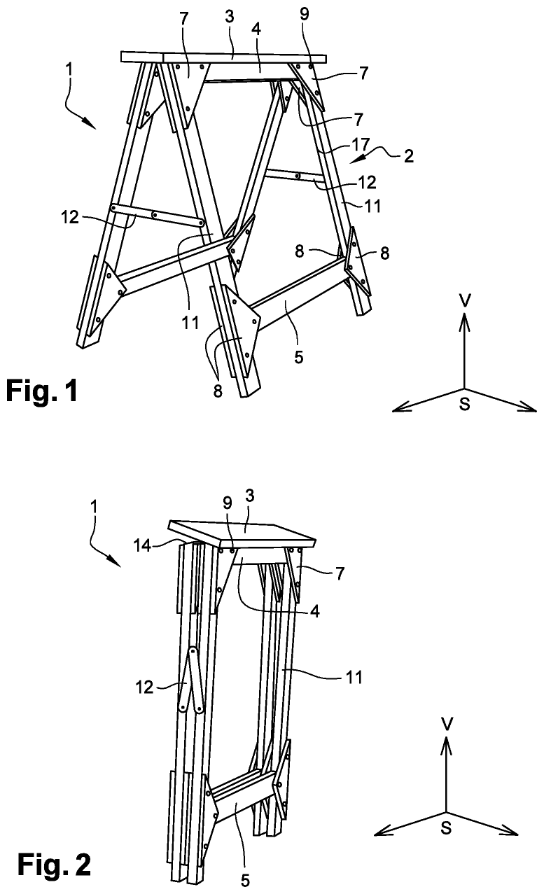

As already indicated, FIG. 1 shows the trestle of the invention in unfolded position, that is, in working mode. The trestle (1) is basically formed of a base (2) and of an upper support surface (3). It rests on the ground (S) via the base (2) and, as can be observed in FIG. 1, the upper support surface (3), located above the base (2), extends perpendicularly to direction V, that is, to the vertical direction.

The different elements forming the trestle are essentially made of wood, only fasteners in addition to the hinged stays (12) described in further detail hereafter being likely to be made of steel or of metal.

The base (2) is formed of two pairs of two posts (11), the posts of each of the two pairs being parallel to each other. Each pair of posts (11) is thus located in a same plane P, the planes being secant when the trestle is in unfolded position (FIGS. 1 to 6), or substantially parallel to each other when the trestle is in folded position (FIG. 2).

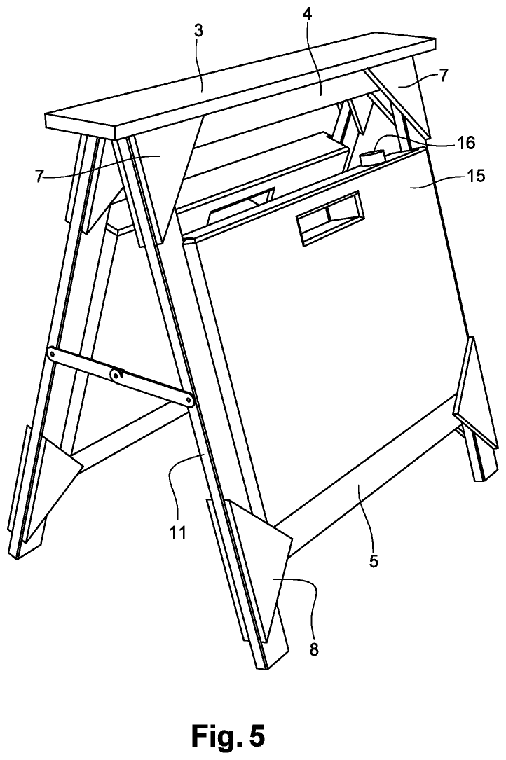

The posts (11), typically having a rectangular cross-section, are connected together by at least one upper crossbar (4) and, further, advantageously by a lower crossbar (5). The crossbars, also of rectangular cross-section, extend between the respective inner lateral surfaces (17) of each of the two posts (11) as can be for example observed in FIG. 4. The crossbars (4) and (5) are fastened by gluing between the posts, the glue used being typically white assembly glue, well known for the gluing of wooden elements together.

Further, and according to a feature of the invention, lateral assembly panels, also called corner pieces (7), are attached at the level of the two upper angles defined by the respective posts (11) and the upper crossbar (4) and this, on either side of the angles thus defined, as can effectively be observed for example in FIGS. 1 and 2, that is, on the outer surface and on the inner surface of each of said angles. Thus, the upper crossbars (4) have the same thickness as the posts (11) to allow the fastening at the level of all the previously-defined angles. The fastening of the corner pieces (7) on either side of the two upper angles of each of the two pairs of posts is performed by gluing, here again, for example, by means of white assembly glue. Advantageously, the fastening is optimized by the insertion of nails, screws or the like illustrated by reference (9) in FIG. 1.

Typically, the lateral assembly panels or corner pieces (7) are made of plywood.

Advantageously, the two posts (11) of each of the two pairs are also connected to each other by a lower crossbar (5), fastened to said posts (11) in t he same way as the upper crossbar (4). Further, lateral assembly panels or lower corner pieces (8) are also fastened at the level of the two lower angles defined by the posts (11) and the lower crossbar (5) and on either side of these angles, as can be observed in FIGS. 1, 2, 3, and 4. Such a fastening is here again performed by gluing, possibly associated with nails, screws, or the like as for the upper corner pieces (7). Indeed, the cross-section of the lower crossbar (5) is rectangular and its thickness is identical to that of the posts (11).

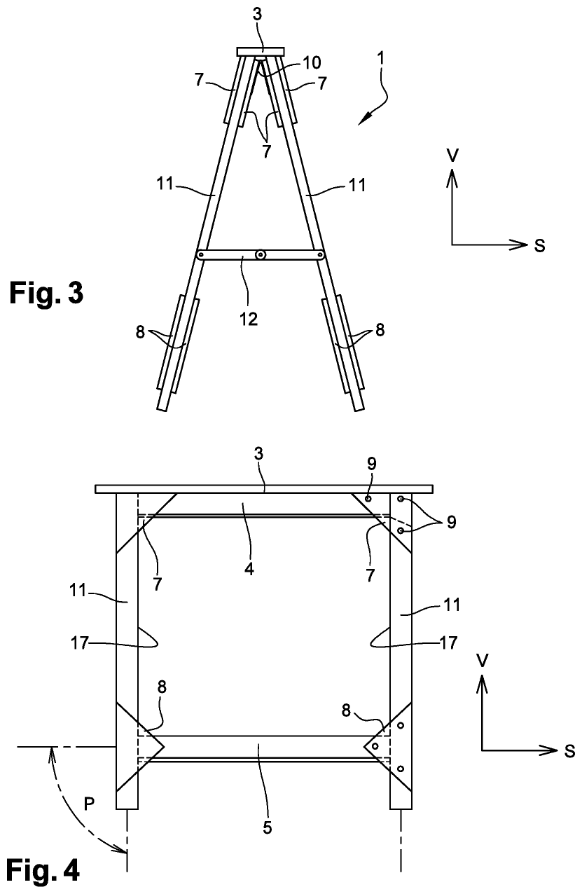

The two pairs are associated with each other and particularly jointed to each other by means of a hinge, and generally jointing means (10) shown in FIG. 3. The hinge(s) are fastened to the outer surface of the inner corner pieces (7), as can be observed in FIG. 3. Thereby, the lower ends of the two pairs of posts can thus be brought closer to each other to obtain the trestle in folded position as illustrated in FIG. 2, or on the contrary drawn away from each other as illustrated in FIG. 1 to have the trestle in working mode. However, the angular clearance of the spacing is limited by hinged stays (12) and this, as known in the art.

According to a feature of the invention, the upper end (14) of each of the posts (11) is tapered, as can for example be observed in FIG. 2. The taper angle is selected so that, when the trestle is in folded position (FIG. 1 or FIG. 3), the support surface or upper shelf (3), which will be discussed hereafter, rests on the entire upper cross-section of each of the four posts (11), as can be observed in FIG. 3. Thereby, the load bearing capacity of said shelf or upper support surface (3) on the base is increased, thus favoring, on the one hand, the load bearing and, on the other hand, the stability of the trestle.

The upper support surface or shelf (3) is fastened, particularly by gluing at the level of the upper end of a single one of the two pairs of posts and, for example, as can be observed in FIG. 2, on the right-hand pair. Thus, in folded position, as can be observed in FIG. 2, it can be observed that the shelves (3) form an angle with respect to the horizontal direction.

The unfolding of the trestle may thus be performed with one hand by positioning the other pair of legs on the ground, that is, that which is not secured to the shelf, and by pulling either on the shelf (3), or on the upper crossbar (4) of the other pair of posts, whereby the trestle can be positioned in working mode in user-friendly and simple fashion.

Further, the presence of corner pieces or of lower lateral assembly panels (8) enables to provide a sufficient spacing of the two pairs of posts when the trestle is in folded position, thus providing a sufficient stability for the trestle to stand upright on the ground in the folded position.

When the stability of the trestle according to the invention is desired to be increased, it is possible to insert a ballast (15) within each of the two pairs of posts, as shown in FIG. 4. The ballast (15) is for example made of plastic material by molding. It is advantageously hollow and is capable of being filled with water or sand. For this purpose, it is provided with an upper opening, capable of being closed by means of a plug (16).

The ballast is typically received in the space defined by the lower crossbar (5) and the two lateral posts (11). It is further inserted in the space defined in each of the two lower angles by the two corner pieces (8) fastened on both sides.

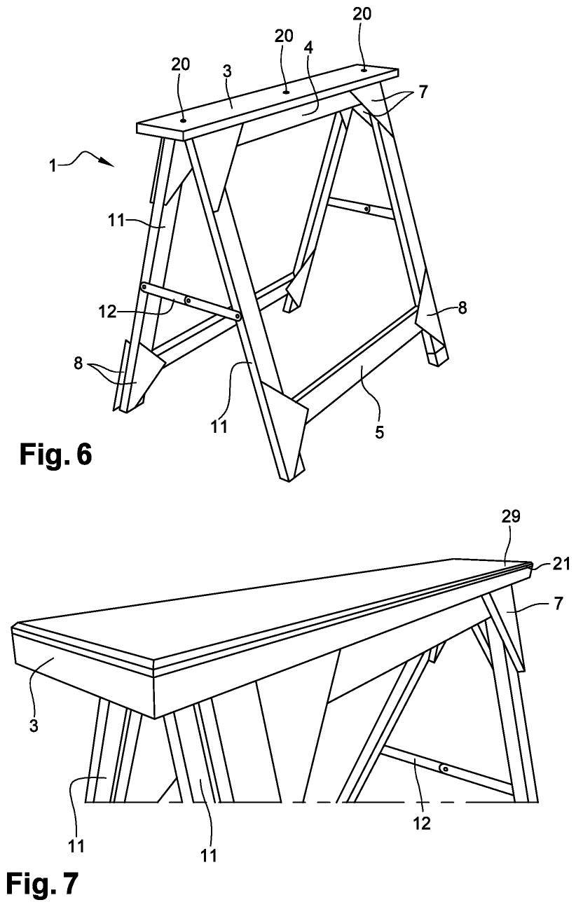

FIG. 6 shows a trestle (1) in working position according to another embodiment of the invention. The trestle is identical to that described in relation with FIGS. 1 to 4, but for the fact that the upper surface or shelf (3) is provided with housings (7) on its upper surface, in the case in point, three, intended to cooperate with the accessories described hereabove.

Among the different accessories, part of them typically comprises a planar element (21), having dimensions equivalent to those of the upper support surface or shelf (3), on which it is intended to rest. The lower surface of said planar element is provided with pins (22) directed perpendicularly to the surface of said planar element and being accommodated in the above-mentioned housings (20) of the support surface or shelf (3). On this regard, the diameter of the pins (22) and of the housings (20) is substantially identical to within the clearance.

The planar element may, in certain embodiments, receive a lining, typically felt or a rubber layer (23) (see FIG. 7), more particularly intended for the handling of finished works to avoid altering said works or mirrors, glazing panels and for the assembly of aluminum frames, intended to avoid the sliding of such elements when they are being handled.

The planar element may also be secured to an H-shaped structure (24) (see FIG. 9). Such an H-shaped structure defines at its center, on either side of the crossbar (25) of the H, two housings (26) receiving beams (27) capable of sliding within said housings (26), and thus enabling the extension of the span of the trestle for elements of larger dimensions. To allow such a sliding, without risking the retraction of the beams (27) out of said housings (26), the cross-section of said beams is typically dovetail shaped and the housings (26) have a complementary cross-section, as can be observed on the back drawing, showing the beams in folded position. The H-shaped structure (24) may further form one piece with the planar element, as further shown in FIG. 9.

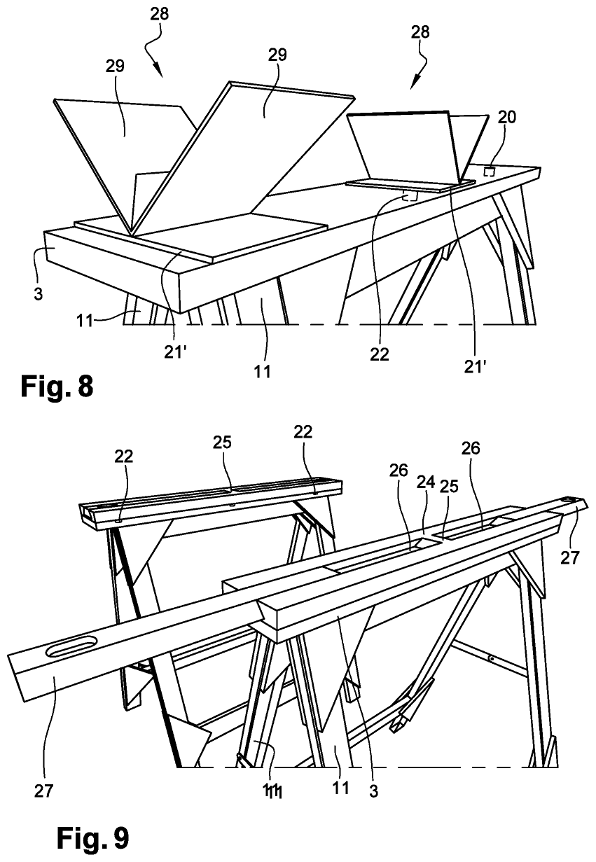

Instead of a single planar element, as described in the previous embodiments, the accessory may comprise two (21′), still meant to rest on the upper support surface or shelf (3) of the trestle (see FIG. 8), and according to the same principle of a locating pin (22) received in a housing (20) of said support surface (3). In this embodiment, the planar element(s) (21′) receive a module (28) for receiving pipes and tubes, for example, made of metal. The module is, in the described example, formed of wings (29) diverging from the considered planar element, defining together an actual area for receiving a tube, pipe, and generally any object, for its cutting, its treatment, etc.

In this embodiment, and since the planar element (21′) is only provided with a single locating pin (22), said planar element, and thus the module (28) which is secured thereto, is capable of being oriented along any direction of the horizontal plane on a 360° scale, provided for the locating pin and for the housing (20) to have a circular cross-section. The user may thus adapt at will the orientation of the object to the treated, received within said module (28).

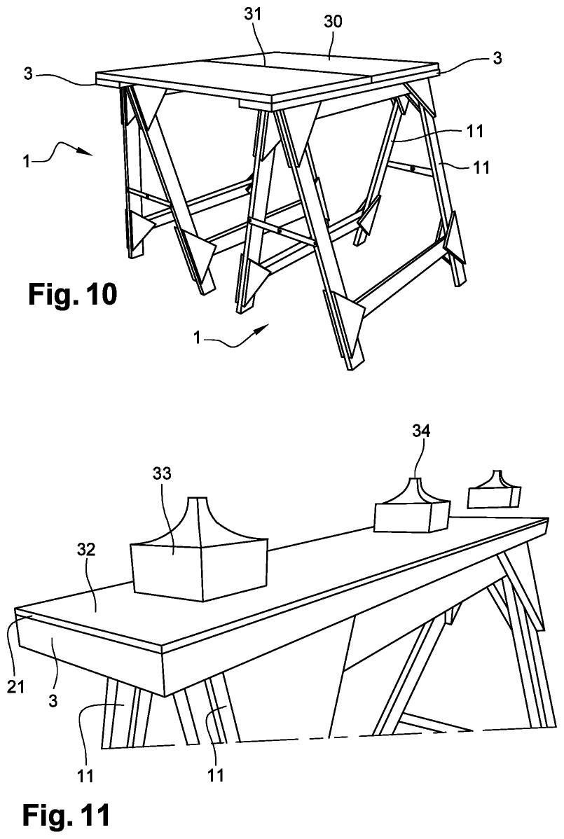

According to another embodiment of the invention, illustrated in FIG. 10, the accessory of the trestle of the invention is formed by a board (30) having a much larger dimension, intended to be used, for example, as a workbench. The board (30), advantageously foldable (by means of a hinge (31)), instead of being received on one trestle, is received on two adjacent trestles parallel to each other, of the type described in relation with FIG. 6, the principle of the positioning of the board on the trestles remaining identical to that previously described. However said board (30) advantageously receives two parallel rows of locating pins, each the rows cooperating with one, respectively the other, of the upper support surfaces (3) of the two trestles.

According to still another accessory of the trestle of the invention, more particularly described in relation with FIG. 11, the planar element (21) is coated with a ferromagnetic material (32) over its entire upper surface, and for example with steel. One or a plurality of blocks (33) having its planar base integrating a permanent magnet (not shown) are thus capable of being positioned on the ferromagnetic surface (32) at the user's will. The block(s) (33) are hollow and are pierced in their upper surface with an opening (34), capable of allowing the introduction within said blocks of a piece or of an object to be painted, or to be varnished. The number of blocks implemented by the user of course depends on the morphology of said piece. It can be understood that thereby, the bearing surface of the piece within the block is particularly small, thus optimizing the duration and the efficiency of the operation of painting or of coating of said piece.

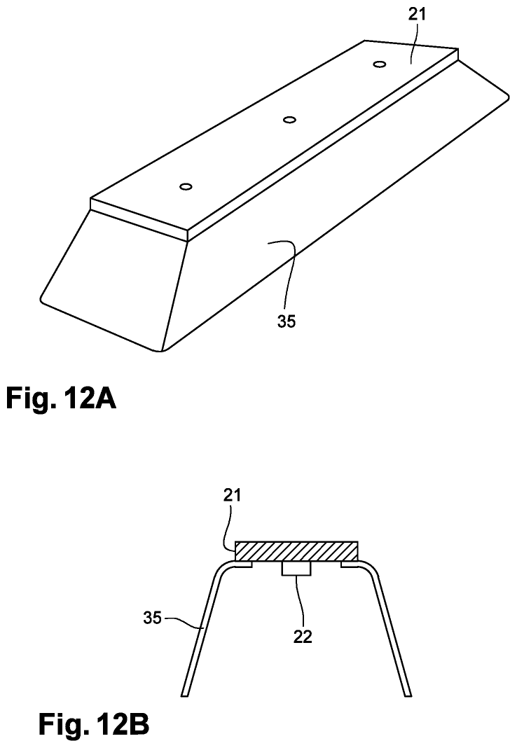

According to another accessory of the trestle of the invention, illustrated in relation with FIGS. 12A and 12B, the planar element (21) is formed of a fireproof shelf, the fireproofing resulting from a peripheral skirt (35) placed at the periphery of the lower surface of said shelf.

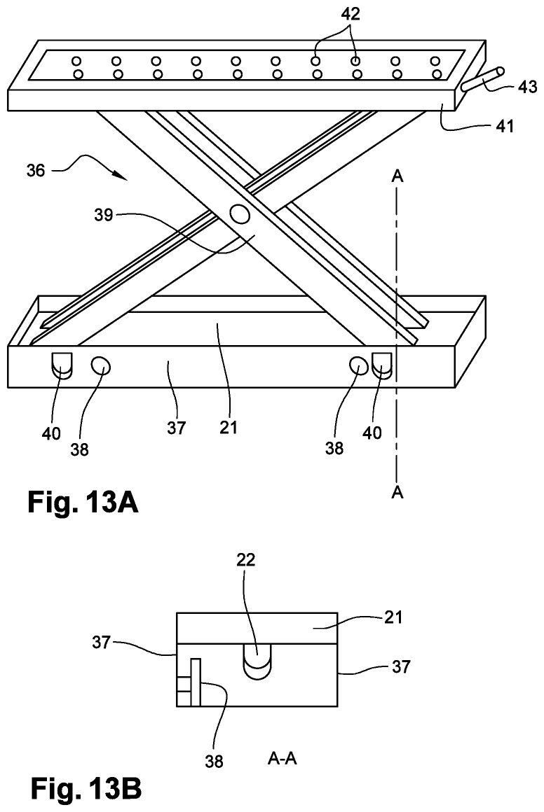

Finally, and according to another accessory of the trestle of the invention shown in FIGS. 13A and 13B, a module provided with an elevated support, capable of easing the user's work for certain tasks, is provided.

The module (36) comprises a planar element (21) intended, as in the previous cases, to be positioned on the upper support surface or shelf (3) of the trestle (1), said planar element being in this case provided with vertical lateral walls (37), which are positioned at the periphery of said upper support surface (3). At least the main lateral walls of said planar element are provided with clamping means (38) capable of cooperating with the periphery of the upper support surface (3) of the trestle, to secure the holding of the module (36) on said trestle.

The planar element (21) is topped with a hinged member (39), having the lower ends of its two branches locked on the upper surface of said planar element (21) by positioning axes (40) received in housings provided for this purpose (not shown) and having its upper ends secured to an upper shelf or bench (41).

The upper surface of the shelf or bench (41) is advantageously provided with microbeads (42) assembled to freely rotate and intended to ease the displacement of an object to be treated, received or positioned thereon. Advantageously, the microbeads (42) may be retracted within the thickness of said bench (41), by the actuation of a handle (43) associated with a mechanism (not shown) integrated within the thickness of said bench (41).

The trestle of the invention has a number of obvious advantages, among which the following can be mentioned:
first, the optimizing of its resistance to the loads that it is likely to receive, due to the stabilizing and the increase in the mechanical resistance of the base;
an optimization of the load also, due to the reception of the support surface or upper shelf on an optimized cross-section of the upper end of the posts, due to their tapered shape;
the stability of the trestle in folded position, due to the presence of lower corner pieces enabling to space apart the two pairs of posts from each other;
an optimized user-friendliness, due to the opening with one hand of said trestle in working position, inherent to the fastening of the shelf or upper support surface on a single one of the pairs of posts;
an optimized modularity of the trestle by means of accessories which are very easy to position on or to release from the planar support surface of said trestle, according to the user's needs.

1. A folding trestle, essentially made of wood, having a folded position and an unfolded working position, comprising:
a base intended to rest on the ground, formed of two pairs of posts parallel to each other, the two posts of each of the pairs being secured together at least by an upper crossbar, said pairs being secured together at the level of at least one upper joint, and
a support surface arranged above the base and secured to said base, and extending perpendicularly to a vertical direction when the trestle is in working position,
wherein the upper crossbars extend between the two posts parallel to each other of each of the two pairs and are secured thereto by gluing;
wherein lateral assembly panels or corner pieces are fastened at least at the level of the upper angles defined by the posts and the associated upper crossbar of each of the two pairs of posts, and on either side of said upper angles;
wherein an upper end of each of the posts is tapered, so that, in working position, the support surface rests on the entire upper cross-section of said posts; and
wherein the support surface is secured only to one of the two pairs of lateral posts.

2. The folding trestle of claim 1, wherein the two posts forming each of the two pairs of the base are also secured together by means of a lower crossbar extending between said posts and glued to said posts.

3. The folding trestle of claim 2, wherein lateral assembly panels or corner pieces are fastened on either side of a lower angle defined by the posts and the lower crossbar.

4. The folding trestle of claim 1, wherein the lateral assembly panels or corner pieces are glued and further nailed or screwed, on the one hand on the respective lateral posts and on the other hand on the respectively upper and lower crossbars.

5. The folding trestle of claim 2, wherein ballasts are removably fastened in each of the pairs of posts, said ballast being received on the lower crossbar and inserted between the lateral assembly panels or corner pieces fastened on either side of the lower angle defined by the posts and the lower crossbar, the ballasts being advantageously hollow and capable of being filled with water or sand.

6. The folding trestle of claim 1, wherein the support surface is provided on one upper surface with housings capable of receiving centering and locking means associated with a planar element intended to be positioned on said support surface, said planar element forming part of a removable accessory.

7. A removable accessory intended to be positioned on the trestle of claim 6, wherein the planar element is provided on its lower surface with at least one centering and fastening pin, capable of being received in a housing having an adapted shape provided for receiving said pin, formed at the level of the support surface of the trestle.

8. The removable accessory of claim 7, wherein the planar element receives on one upper surface a soft lining, of felt type, more particularly intended for the handling of finished works.

9. The removable accessory of claim 7, wherein the planar element receives on one upper surface a soft anti-skid lining of rubber type, particularly for the handling of mirrors, of glazing panels, or even the assembly of aluminum frames.

10. The removable accessory of claim 7, wherein the planar element receives on one upper surface means capable of increasing the load bearing capacity of the trestle with which it is associated, these means being formed of beams sliding in housings defined by an H-shaped structure placed on the upper surface of said planar element.

11. The removable accessory of claim 10, wherein the sliding beams have a dovetail-shaped cross-section and are received in a housing of complementary shape defined by the H-shaped structure.

12. The removable accessory of claim 7, wherein the planar element is provided with areas for receiving tubes or pipes defined by a dihedron, the lower surface of said planar element comprising a single locating pin on the support surface of the trestle, said accessory being orientable according to any direction of the horizontal plane containing said planar element.

13. The removable accessory of claim 7, wherein the planar element is formed of a planar surface of large dimension capable of resting on two trestles erected parallel to each other, said planar surface receiving two parallel rows of locating pins.

14. The removable accessory of claim 7, wherein the planar element is coated on one upper surface with a ferromagnetic material intended to receive one or a plurality of blocks provided at their base with a permanent magnet, capable of enabling their positioning and fastening in a location selected by the operator on a planar element thus coated, said blocks being themselves provided with an opening for receiving a piece or an object to be treated.

15. The removable accessory of claim 7, wherein the planar element is provided with a peripheral skirt made of a fireproof fabric, placed on the lower surface of said planar element and all along the periphery thereof.

16. The removable accessory device of claim 7:
wherein the planar element is provided with vertical lateral walls capable of positioning at the periphery of the upper support surface of the trestle, and provided with clamping and holding means, acting in cooperation with said periphery of said upper support surface;
wherein the planar element is topped with an unfolding and folding hinged member having an upper shelf or bench, also planar, extending substantially parallel to the planar element in working position, positioned at the upper end thereof.

17. The removable accessory of claim 16, wherein an upper surface of the upper shelf or bench receives a plurality of microbeads capable of being retracted within the thickness of said upper shelf or bench.
